(19) United States
(12) Patent Application Publication
(10) Pub. No.: US 2016/0112636 A1
(43) Pub. Date: Apr. 21, 2016

(54) WEARABLE CAMERA

(71) Applicant: Panasonic Intellectual Property Management Co., Ltd., Osaka (JP)

(72) Inventors: Kazuhiko Yamaguchi, Fukuoka (JP); Yasushi Yokomitsu, Fukuoka (JP); Haruo Tagawa, Fukuoka (JP); Masayuki Sakigawara, Fukuoka (JP)

(21) Appl. No.: 14/880,732

(22) Filed: Oct. 12, 2015

(30) Foreign Application Priority Data
Oct. 20, 2014 (JP) 2014-213453
Dec. 25, 2014 (JP) 2014-262156

(51) Int. Cl. H04N 5/232

(52) U.S. Cl. CPC H04N 5/23245; H04N 5/23293

(57) ABSTRACT

A wearable camera includes a body, a lens, a video recording button, a snap shot button, a mode changeover switch, and a confirmation changeover switch. The mode changeover switch includes an operating section and a linear slot in which the operating section moves. A first mode which is a most-frequently-used mode having a high frequency of use in case of emergency is disposed on an upper end side of the slot, and a fourth mode which is an off mode cutting off connection with the outside is disposed on a lower end side thereof.

### BACKGROUND OF THE INVENTION

1. Field of the Invention

The present disclosure relates to a wearable camera which is worn by a police officer and the like.

2. Description of the Related Art

In recent years, particularly in the United States, difficulties in verification regarding discharging of gun and the like executed by a police officer, have become a problem. Therefore, in order to image the circumstances of a scene in an emergency situation and to turn the images into verification of the account of the events thereafter, police officers tend to wear a wearable camera. There is a known wearable camera which is carried on oneself and is capable of automatic imaging.

Japanese Patent Unexamined Publication No. 2004-356970 discloses a wearable camera in which when a sound taken by a sound input section is a sound within a predetermined range of sounds while the camera is carried by an image taker, a trigger detector generates a trigger detection signal and imaging is automatically performed.

A police officer that arrives at the scene upon a request of emergency dispatch and the like needs to operate the wearable camera during the investigation, and the operation needs to be smoothly carried out in an emergency and strained situation. However, the configuration of the wearable camera disclosed in Japanese Patent Unexamined Publication No. 2004-356970 has a disadvantage in that the aforementioned circumstances are not taken into consideration.

### SUMMARY OF THE INVENTION

An objective of the present disclosure is to provide a wearable camera which is set in an operation mode so as to be able to instantly perform imaging at the scene.

According to an aspect of the present disclosure, there is provided a wearable camera including a body, a video recording button that is provided on a frontal face of the body in an area on one side having one center line on the frontal face as a boundary, and a mode changeover switch that is provided on a side of the body existing in the area on the one side. The mode changeover switch includes an operating section which is directly operated by an operator, and a linear slot in which the operating section moves. A most-frequently-used mode having the highest frequency of use in case of emergency is positioned in at least one end of the slot.

As an aspect of the wearable camera according to the present disclosure, for example, the most-frequently-used mode is a mode for performing communication with a portable electrical apparatus.

As an aspect of the wearable camera according to the present disclosure, for example, a communication off mode is positioned in the other end of the slot.

As an aspect of the wearable camera according to the present disclosure, for example, at least one external apparatus connection mode which can be connected to an external apparatus is positioned between the one end and the other end of the slot.

According to the wearable camera of the present disclosure, the video recording button is disposed on one side having the center line as a boundary on the frontal face of the body of the wearable camera, and the mode changeover switch is disposed on the side thereof. Therefore, for example, the video recording button and the mode changeover switch can be easily operated with the index finger while putting a hand on the chest. As a mode having the highest frequency of use in case of emergency is positioned at the one end of the slot, the video recording button and the mode changeover switch can be appropriately used at the same time even in case of emergency. Since button is provided in the area on one side having the center line as a boundary, operability of the video recording button is improved.

### BRIEF DESCRIPTION OF DRAWINGS

FIG. 1 is a schematic diagram illustrating an example of an overall image of a wearable camera system which uses a wearable camera according to the present disclosure;

FIG. 2A is a front view illustrating an exemplary embodiment of the wearable camera according to the present disclosure;

FIG. 2B is a right side view illustrating the exemplary embodiment of the wearable camera according to the present disclosure;

FIG. 3 is a conceptual diagram illustrating an example of an equipped state of the wearable camera according to the present disclosure;

FIG. 4A is a diagram illustrating an example of a mode changeover switch of the wearable camera according to the present disclosure and illustrating that an operating section is at a first mode position;

FIG. 4B is a diagram illustrating an example of the mode changeover switch of the wearable camera according to the present disclosure and illustrating that the operating section is at a fourth mode position;

FIG. 5 is a block diagram illustrating an example of a configuration of the wearable camera according to the present disclosure;

FIG. 6 is a flow chart illustrating an example of a start and a stop of video recording performed with the wearable camera according to the present disclosure;

FIG. 7 is a diagram illustrating an equipped state of the wearable camera according to an alternative exemplary embodiment of the present disclosure;

FIG. 8 is a perspective view of the wearable camera according to the alternative exemplary embodiment;

FIG. 9 is a top view of the wearable camera according to the alternative exemplary embodiment;

FIG. 10 is a right side view of the wearable camera according to the alternative exemplary embodiment;

FIG. 11 is a diagram illustrating a necessary angle for an inclination angle of the top face of the wearable camera according to the alternative exemplary embodiment;

FIG. 12 is a top view of the wearable camera according to another alternative exemplary embodiment; and

FIG. 13 is a cross-sectional view taken along line A-A illustrating an enlarged configuration of the top face portion of the wearable camera illustrated in FIG. 12.

### DETAILED DESCRIPTION OF THE PREFERRED EMBODIMENTS

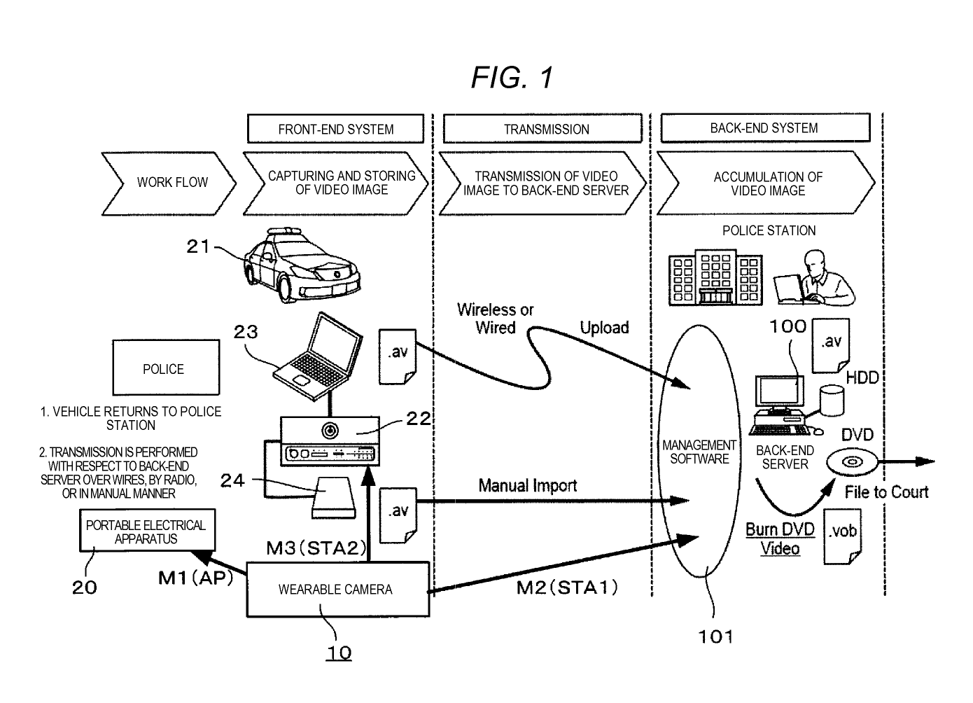

Hereinafter, favorable exemplary embodiments of a wearable camera according to the present disclosure will be described in detail with reference to FIGS. 1 to 6.

FIG. 1 is a schematic diagram illustrating an example of an overall image of a wearable camera system which uses wearable camera 10. From the left to the right, the diagram illustrates a front-end system in which wearable camera 10 is directly adopted, transmission in which data is sent from the front-end system, and a back-end system in which transmitted information is processed.

Wearable camera 10 (WCAM) worn by a police officer that is an example of an operator (a user) is adopted in the front-end system and mainly performs capturing and storing of video images. Particularly, wearable camera 10 is an image capturing device with which a police officer can be equipped in order to acquire and retain evidential video images of the scene in a more unerring manner. The wearable camera system includes wearable camera 10; portable electrical apparatus 20; in-car video recorder 22 and PC (personal computer) 23 which are mounted on patrol car 21 or the like; and server 100. Wearable camera 10, in-car video recorder 22, and PC 23 are provided in the front-end system, and server 100 is provided in the back-end system.

For example, portable electrical apparatus 20 may be a smart phone, a portable telephone, a tablet terminal, or a personal digital assistant (PDA) which can be easily carried. Portable electrical apparatus 20 may be PC 23 which is mounted on patrol car 21. Portable electrical apparatus 20 may be a wireless communication device as long as the apparatus is provided with an input section, an authentication section, and the like, and can communicate with wearable camera 10 utilizing the Wi-Fi (registered trademark) and the like. Portable electrical apparatus 20 can perform displaying of a video-recorded image which is captured by wearable camera 10, reproduction of the video-recorded image, tagging of attribute information of the video-recorded image, bookmarking of the video-recorded image, case-numbering of the video-recorded image, displaying of an imaged video image (a still image in video), confirmation of remaining battery power of wearable camera 10, and confirmation of the available space on a memory for retaining video images of wearable camera 10.

The front-end system is configured to include wearable camera 10 which is worn by a police officer that is dispatched to the front lines of the scene, portable electrical apparatus 20, patrol car 21 in which the police officer rides, and in-car video recorder 22 which is installed inside patrol car 21. For example, a video image of the scene at which patrol car 21 arrives is captured by wearable camera 10, and a data file of the captured video image is retained and accumulated in the memory for retaining video images inside wearable camera 10, portable electrical apparatus 20, in-car video recorder 22 (or, in external storage SSD 24, as necessary). For example, external storage SSD 24 is a hard disk drive or a solid-state drive.

In-car video recorder 22 is connected to wearable camera 10 and portable electrical apparatus 20 in between thereof so as to be able to communicate with one another. In-car video recorder 22 transmits the data file of the captured video image to portable electrical apparatus 20 using wearable camera 10, or in-car video recorder 22 itself retains and accumulates the data file.

A police officer, when being dispatched from a police station to carry out a predetermined duty (for example, patrols), takes out wearable camera 10 from the police station and connects wearable camera 10 to in-car video recorder 22 which is installed in patrol car 21 so as to be able to communicate therewith. PC 23 performs displaying of the video-recorded image which is captured during patrols, reproduction of the video-recorded image, tagging of attribute information of the video-recorded image, bookmarking of the video-recorded image, case-numbering of the video-recorded image, displaying of an imaged video image (a still images in video), and the like in accordance with an operation of the police officer using wearable camera 10 and in-car video recorder 22. When patrol car 21 returns to the police station after completing the patrols, the data file of a video image accumulated in wearable camera 10 is transmitted to server 100 (for example, a predetermined back-end server installed in the police station) over wires, by wireless, or in a manual manner (for example, hand-carrying of storage medium). Without being limited to wearable camera 10, video images accumulated in portable electrical apparatus 20 and in-car video recorder 22 (in addition, external storage SSD 24, as necessary) may be transmitted.

The back-end system is configured to include server 100 which is installed in the police station, management software 101 for communicating with the front-end system, and an external hard disk (HDD) which is connected to server 100 as storage. The data file of video images transmitted from wearable camera 10, portable electrical apparatus 20, and in-car video recorder 22 which are in the front-end system is retained and accumulated in the storage inside server 100. The data file of a video image accumulated in the back-end system is utilized by a person in charge in the relevant department of the police station, for example. As necessary, the data of a video image is copied into a predetermined storage medium (for example, DVD: digital versatile disk) and is submitted to a predetermined scene (for example, trial) as evidence.

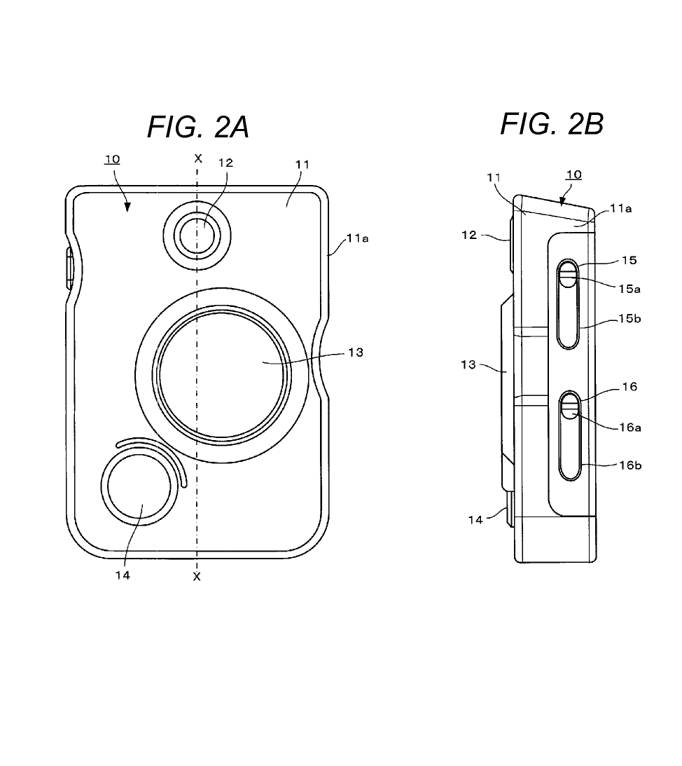

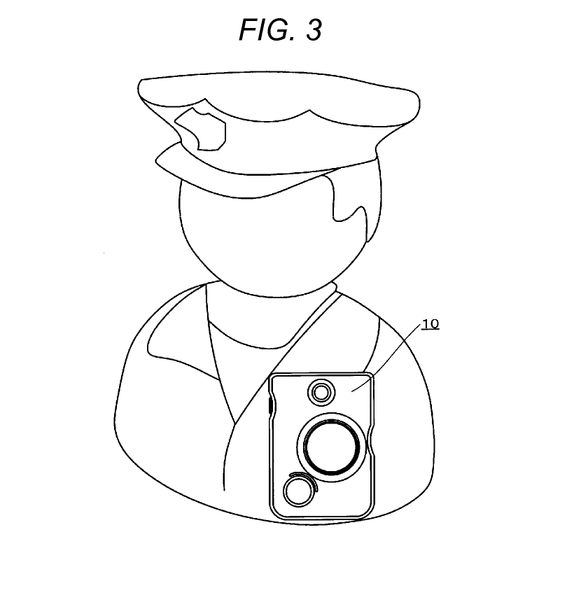

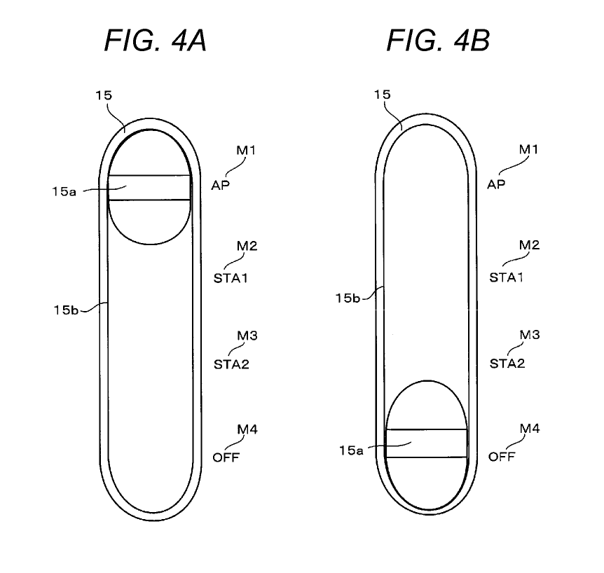

Wearable camera 10 will be described in detail with reference to FIGS. 2A and 2B to FIGS. 4A and 4B. FIG. 2A is a front view illustrating an example of wearable camera 10, and FIG. 2B is a right side view of the same. FIG. 3 is a conceptual diagram illustrating an example of an equipped state of wearable camera 10. FIG. 4A illustrates an example of mode changeover switch 15 of wearable camera 10 and illustrates that operating section 15a is at a position of first mode M1, and FIG. 4B illustrates that operating section 15a is at a position of fourth mode M4.

As illustrated in FIG. 3, a police officer is equipped with wearable camera 10 in the vicinity of the chest, for example. It is desirable to be equipped on the left side of the body in terms of operability when the police officer is right-handed, and to be equipped on the right side of the body when the police officer is left-handed. As illustrated in FIG. 2, wearable camera 10 includes substantially square body 11, lens 12, video recording button 13, snap shot button 14, mode changeover switch 15, and confirmation changeover switch 16.

Lens 12 is an optical member which acquires a video image to be captured, and video recording button 13 is a button which is operated at the time of starting or ending in capturing of a video image. Since there are various factors at the scene, in order to prevent video recording button 13 from being easily turned ON and OFF, for example, a method in which capturing of a moving image (a video image) starts by pressing the button an odd number of times, and capturing of motion (a video image) ends by pressing the button an even number of times may be provided. Capturing of a moving image (a video image) may easily start by pressing the button once, but a long press of the button may be required in capturing of motion (a video image) so as to cause only the ending to be not easily executed. Snap shot button 14 is a button which is operated when capturing a still image.

Video recording button 13 is provided on a frontal face of body 11 in an area on one side having one center line X-X on the frontal face as a boundary. As illustrated in FIG. 2, a portion of video recording button 13 may be straddled over center line X-X or may be disposed on only one side of center line X-X. When being equipped with wearable camera 10 on the left side of the body, it is desirable that video recording button 13 is provided on the left side of center line X-X, thereby improving operability. Center line X-X described above is on a line which vertically passes through a substantial center (or a center of balance) of body 11. However, center line X-X may be on a line which is positioned between the thumb and other fingers when an operator that is a police officer grasps body 11 with the thumb and other fingers.

Since there is no time to spare for performing a complicated operation or searching for video recording button 13 at the scene of an emergency situation, it is desirable that video recording button 13 can be simply operated with one hand so that video recording button 13 is provided in the area on one side having center line X-X as the boundary, thereby improving operability of video recording button 13.

Mode changeover switch 15 is provided on side 11a of body 11 existing on the area side where video recording button 13 is disposed. Mode changeover switch 15 includes operating section 15a which is directly operated by an operator that is a police officer, and linear slot 15b in which operating section 15a moves (in the vertical direction of body 11). Mode changeover switch 15 includes four modes in the present exemplary embodiment (refer to FIGS. 4A and 4B). First mode M1 is disposed on the upper end side of slot 15b followed by second mode M2 and third mode M3. Furthermore, fourth mode M4 is disposed on the lower end side thereof. The number and the type of modes can be suitably changed.

First mode M1 is positioned as a most-frequently-used mode having a high frequency of use in case of emergency. In the present exemplary embodiment, first mode M1 is displayed as communication connection mode access point (AP) for portable electrical apparatus 20. Second mode M2 is displayed as connection mode STA1 for server 100 provided in the back-end system. A police officer returns to the police station after dispatch is accomplished, and transmits video image data recorded in wearable camera 10 to server 100 by setting connection mode STA1.

Third mode M3 is displayed as external apparatus connection mode STA2 for in-car video recorder 22 (or external storage SSD 24, as necessary) which is mounted inside patrol car 21. Fourth mode M4 is displayed as communication off mode OFF which cuts off connection with the outside.

In each of modes M1 to M4 described above, most-frequently-used mode AP having a high frequency of use in case of emergency is positioned at the upper end of slot 15b, communication off mode OFF is positioned at the lower end which is the other end of the upper end, and external apparatus connection modes STA1 and STA2 at which wearable camera 10 can be connected to the external apparatuses (for example, server 100, in-car video recorder 22, and the like) are positioned between the upper end and the lower end of slot 15b.

Video recording button 13 is disposed substantially on one side from center line X-X on the frontal face of body 11 of wearable camera 10, and mode changeover switch 15 is disposed on the side thereof. Therefore, for example, video recording button 13 and mode changeover switch 15 can be easily operated with the index finger while putting a hand to the chest. As first mode M1 having the highest frequency of use in case of emergency is positioned at one end (the upper end) of slot 15b, video recording button 13 and mode changeover switch 15 can be appropriately used at the same time even when wearing gloves in case of emergency.

When video recording button 13 is pressed and wearable camera 10 starts to image the scene, it is possible to immediately ensure association (communication and the like) with portable electrical apparatus 20 which is the most important element in case of emergency. Since external apparatus connection modes STA1 and STA2 are provided between the upper end and the lower end of slot 15b, it is possible for a police officer to reliably activate wearable camera 10 with composure in the police station before and after dispatch. If the connection for wireless communication such as the Wi-Fi (registered trademark) with the outside is in the ON state (any mode other than OFF), since capacity fade of a built-in battery of wearable camera 10 is accelerated, it is necessary to be certainly in the OFF state other than when needed. Therefore, it is desirable that fourth mode M4 which is the communication off mode is disposed at the lower end (the other end) of slot 15b. External device connection modes STA1 and STA2 are preferably adopted for the connection with the external apparatuses (for example, server 100, in-car video recorder 22, and the like) which are not portable, that is, are fixed. Since the modes are unlikely to be activated at the scene and are less likely to require urgency, it is desirable for the modes to be disposed between the upper end and the lower end of slot 15b.

The above-described connection may be communication connection utilizing the Wi-Fi (registered trademark) and the like, or may be performed over wires or in a manual manner as well.

Similar to mode changeover switch 15, confirmation changeover switch 16 provided on side 11a of body 11 existing in the area where video recording button 13 is disposed. Confirmation changeover switch 16 includes confirmation operating section 16a which is directly operated by an operator that is a police officer, and linear confirmation slot 16b in which confirmation operating section 16a moves. Lights-on and lights-out of below-described LED 32 provided in wearable camera 10, and an operation of a vibrator are performed by operating confirmation operating section 16a. For example, there are provided four types of modes such as LED 32 lights-on, the vibrator ON, both LED and the vibrator ON, and OFF at the lower end from the upper end of confirmation slot 16b, similar to mode changeover switch 15. However, the configuration of confirmation changeover switch 16 is not particularly limited, and confirmation changeover switch 16 itself is not required.

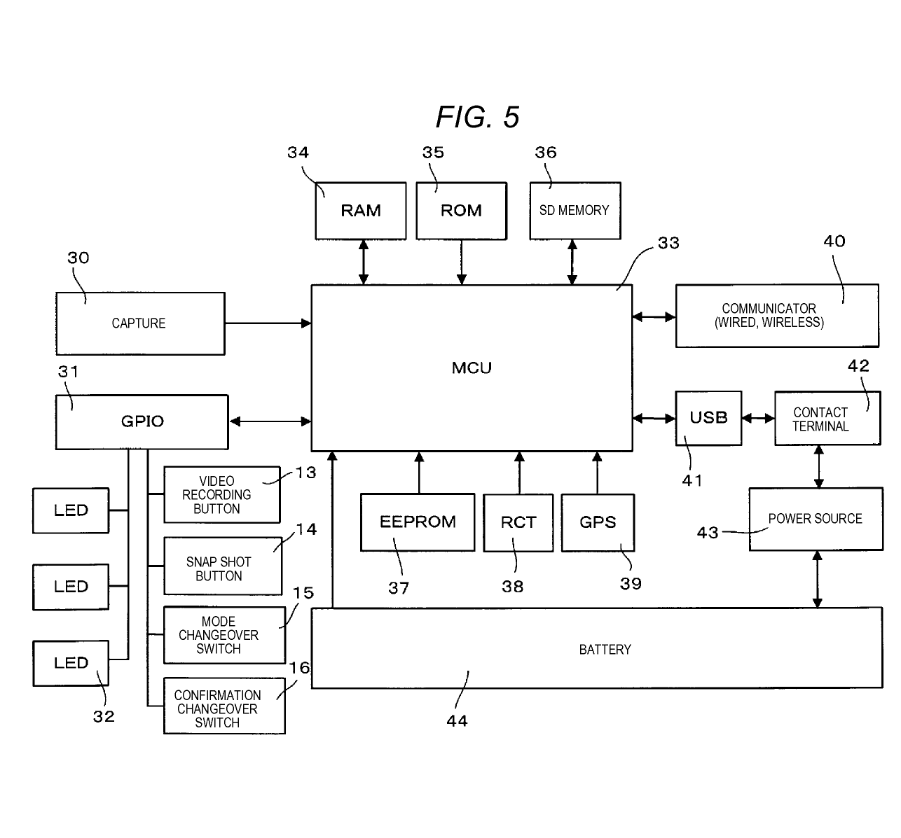

Subsequently, configuration of wearable camera 10 will be described with reference to the block diagram in FIG. 5.

In addition to video recording button 13, snap shot button 14, mode changeover switch 15, and confirmation changeover switch 16 described above, wearable camera 10 includes capture 30, general purpose input/output (GPIO) 31, LED 32, and micro control unit (MCU) 33. In addition, wearable camera 10 includes random access memory (RAM) 34, read only memory (ROM) 35, and SD memory 36, electrically erasable programmable read-only memory (EEPROM) 37 in addition to the aforementioned elements. Moreover, wearable camera 10 includes real time clock (RTC) 38, global positioning system (GPS) 39, and communicator 40. Furthermore, wearable camera 10 includes universal serial bus (USB) 41, contact terminal 42, power source 43, and battery 44.

In addition to lens 12 described above, capture 30 includes a solid-state imaging device of a charge coupled device-type (CCD) image sensor or a complementary metal oxide semiconductor-type (CMOS) image sensor. Capture 30 outputs a data file of a video image obtained through capturing to MCU 33. GPIO 31 is a parallel interface and performs inputs and outputs of signals among video recording button 13, snap shot button 14, mode changeover switch 15, confirmation changeover switch 16, LED 32, and MCU 33 described above. LED 32 indicates the power supply state of wearable camera 10, and light is on as a power button (not illustrated) is pressed down.

MCU 33 performs control processing for generalizing overall operations of each section in wearable camera 10, input-output processing of data with respect to each of other sections, and computation (calculation) processing of data and storing processing of data. MCU 33 is operated in accordance with the program and data stored in ROM 35. MCU 33 uses RAM 34 during the operation, obtains current time information from RTC 38, and obtains current positional information from GPS 39.

MCU 33 detects a pressing-down state of each of the buttons in video recording button 13 and snap shot button 14, and an operational state of mode changeover switch 15 and confirmation changeover switch 16, thereby performing processing with respect to the operated button. That is, when video recording button 13 is pressed down, MCU 33 retains a data file of a video image obtained from capture 30 in SD memory 36 as a moving image. When snap shot button 14 is pressed down, MCU 33 retains the image data at the time snap shot button 14 is pressed in SD memory 36 as a still image. For example, when video recording button 13 is pressed down an odd number of times, MCU 33 may turn on the light of LED 32, and when video recording button 13 is pressed down an even number of times, MCU 33 may turn out the light of LED 32. In response to the operation of mode changeover switch 15, MCU 33 ensures communication connection with respect to external apparatuses such as communicator 40 and portable electrical apparatus 20 in accordance with the aforementioned descriptions. Moreover, MCU 33 controls lights-on and lights-out of LED 32 and the vibrator in response to the operation of confirmation changeover switch 16.

MCU 33 performs capturing of moving images, capturing of still images, and wireless communication. However, MCU 33 can also perform processing related to authentication of a user of wearable camera 10 with respect to portable electrical apparatus 20 (including PC 23). For example, a police officer ID (“officer ID”) which is applied to a police officer in advance is associated with an obtained data file of a video image which is captured by the police officer with the carrying wearable camera 10, through portable electrical apparatus 20. Therefore, it is possible to easily grasp that which police officer has captured the data file of a video image.

RAM 34 is configured to include a non-volatile or volatile semiconductor memory. RAM 34 is a working memory which is used when operating MCU 33. ROM 35 is configured to include a non-volatile or volatile semiconductor memory. A program and data for operating and controlling MCU 33 are stored in ROM 35 in advance. SD memory 36 stores the obtained data file of a video image which is captured by capture 30. SD memory 36 is attachable to and detachable from body 11 of wearable camera 10.

EEPROM 37 stores an identification number (serial number) for identifying wearable camera 10. RTC 38 counts current time information and outputs the information to MCU 33. GPS 39 receives current positional information of wearable camera 10 from a GPS transmitter and outputs the information to MCU 33, for example.

For example, communicator 40 defines the connection between communicator 40 and MCU 33 in a physical layer which is a first layer in an open systems interconnection (OSI) reference model and performs wireless communication (for example, Wi-Fi (registered trademark)) with portable electrical apparatus 20 in accordance with the definition thereof. USB 41 is a serial bus which allows wearable camera 10 to perform communication connection with the electrical apparatus. power source 43 is a power source supplied from a cradle or an external adaptor (not illustrated) via contact terminal 42 and charges battery 44. Battery 44 supplies power to each of the sections in wearable camera 10.

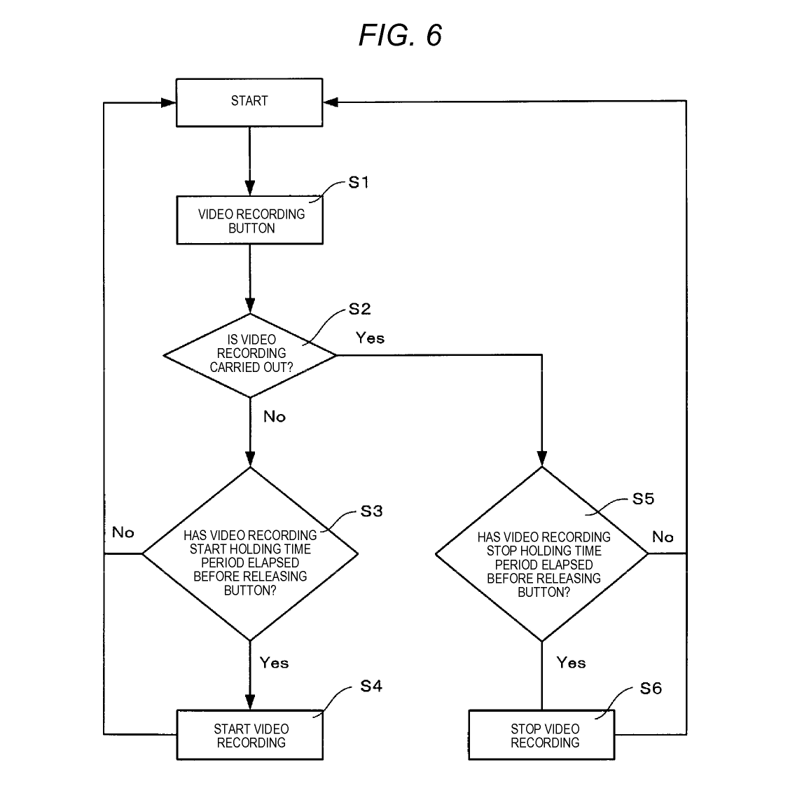

FIG. 6 is a flow chart illustrating an example of a start and a stop of video recording performed with wearable camera 10.

As video recording button 13 is pressed down (Step S1), MCU 33 determines whether or not video recording is carried out (Step S2). When it is determined that video recording is not carried out (No in Step S2), MCU 33 determines whether or not a video recording start holding time period (for example, within one second) has elapsed before releasing video recording button 13 (Step S3). When the video recording start holding time period has elapsed (Yes in Step S3), video recording of wearable camera 10 starts (Step S4). When it is determined that video recording is carried out (Yes in Step S2), MCU 33 determines whether or not a video recording stop holding time period (for example, approximately three seconds) has elapsed before releasing video recording button 13 (Step S5). When it is determined that the video recording stop holding time period has elapsed (Yes in Step S5), video recording stops (Step S6).

In addition to the above-described configuration of wearable camera 10 (refer to FIG. 5), descriptions are given regarding that communication can be performed through the Wi-Fi (registered trademark) with respect to portable electrical apparatus 20, and in-car video recorder 22, server 100, and the like which are external apparatuses. However, short-haul communication may be performed through the Bluetooth (registered trademark). When wireless communication is performed through the Bluetooth (registered trademark), a chip allowing wireless communication may be built inside thereof.

If wireless communication between patrol car 21 and portable electrical apparatus 20 is disconnected, wearable camera 10 may automatically start video recording (image capturing). Particularly, since the communication method performed through the Bluetooth (registered trademark) has a communication range of a little over ten meters, for example, that is shorter than the communication method performed through the Wi-Fi (registered trademark), video recording (image capturing) can automatically start at once when a police officer leaves patrol car 21. Therefore, it is possible to improve user-friendliness of wearable camera 10.

The chip which allows wireless communication (for example, Bluetooth (registered trademark)) may be built inside a fixture of wearable camera 10 (for example, a clip or the like for hooking wearable camera 10 to the uniform of a police officer) or may be built inside wearable camera 10.

Data files of video images may be graded with predetermined priority levels, and wearable camera 10 may perform transmission (uploading) with respect to portable electrical apparatus 20 or server 100 from the important data file of a video image according to the priority thereof in order to cope with the emergency situation. For example, wearable camera 10 refers to case numbers (case file numbers) or classifications for the predetermined priority levels regarding the data files of video images which are input via portable electrical apparatus 20. Wearable camera 10 transmits (uploads) a data file of a video image which corresponds to a particular case number or a particular classification. When there is no priority level, wearable camera 10 may perform transmission (uploading) with respect to server 100 in sequence from the data file of a video image having the preceding captured time.

Wearable camera 10 according to the present exemplary embodiment is described on the assumption of being used in a police station, for example. However, a user is not limited to a police officer. Wearable camera 10 may also be used in other various places of work being active at the scene in case of emergency (for example, a security company, a fire station, and a gas company).

The present disclosure is not limited to the above-described exemplary embodiments, and can be suitably changed and modified. Moreover, the material, the shape, the measurement, the numerical value, the form, the numbers, the location of disposition, and the like of each configurational element in the above-described exemplary embodiment are arbitrary with no limitation as long as the present disclosure can be realized.

Subsequently, an alternative exemplary embodiment of the wearable camera will be described with reference to the drawings.

### Alternative Exemplary Embodiment

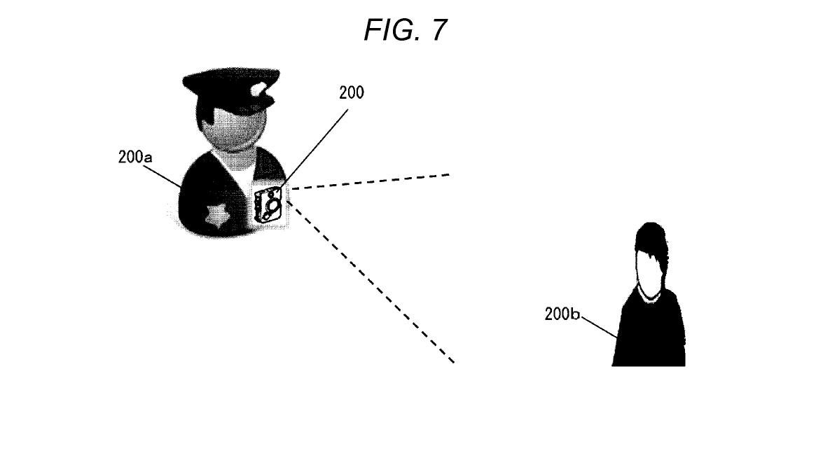

FIG. 7 is a diagram illustrating an equipped state of wearable camera 200 according to the alternative exemplary embodiment. In FIG. 7, police officer 200a, that is, a user is equipped with wearable camera 200 on the chest portion of the uniform.

Wearable camera 200 may be equipped by using a dedicated mounting fixture or may be equipped by being inserted into a pocket of the uniform of police officer 200a. In FIG. 7, wearable camera 200 is equipped by a method using the former mounting fixture, and wearable camera 200 is in a state where the overall appearance can be seen.

In wearable camera 200, as described below, since a lens portion is configured to be positioned in an upper portion of the front face of the camera, even though wearable camera 200 is inserted into a pocket of the uniform of police officer 200a as that in the latter case, it is possible to perform imaging as long as the lens portion is sticking out from the pocket.

Wearable camera 200 captures video images of surrounding circumstances including suspicious person 200b and the like at all times or as necessary during patrols in accordance with an operation performed by police officer 200a. The image capturing status can be visually recognized by police officer 200a through emission of light from the LED arranged on a top face of wearable camera 200 as described below.

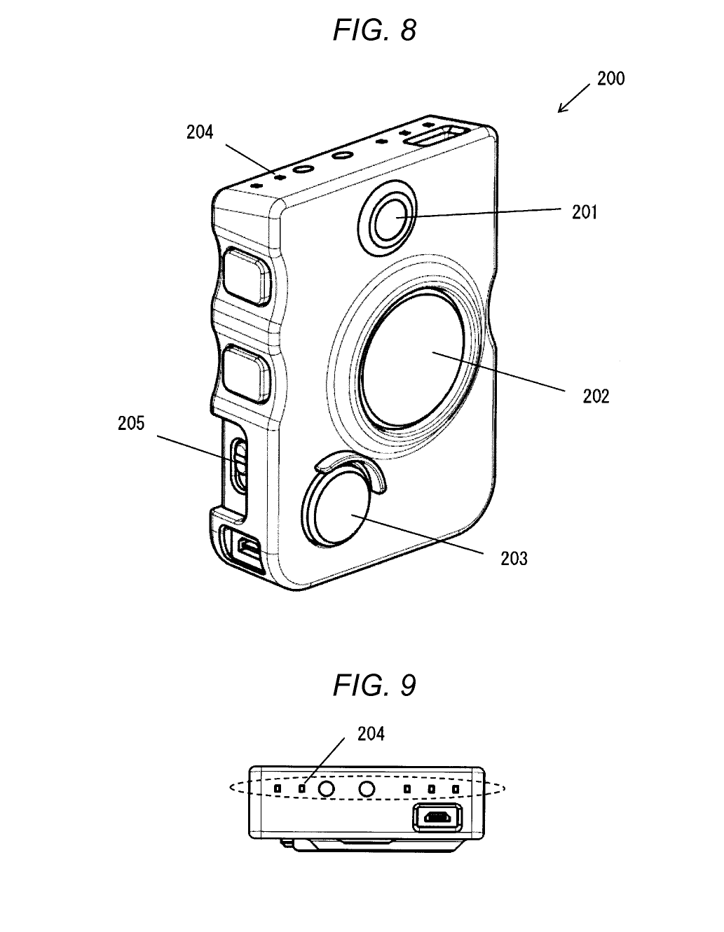

FIG. 8 is a perspective view of wearable camera 200 according to the present exemplary embodiment. Wearable camera 200 illustrated in FIG. 8 is different from the wearable camera described in FIGS. 2A and 2B regarding the configuration of the buttons on the side portion. However, the configurations for the mode changeover switch according to the disclosure are identical to each other. In FIG. 8, on the front face of the body formed to have a substantially rectangular shape, wearable camera 200 includes image capturing lens 201 for capturing an imaging target, video recording button 202 for operating starting of video recording, and snap shot button 203 for operating imaging of a still image.

The top face of the body includes multiple LEDS 204 which are displays for displaying various states related to image capturing (for example, a state of video recording, a state related to communication, a state of remaining capacity for video recording, a state of capacity fade of a battery, and the like).

The side of the body (the left side in FIG. 8) is provided with power switch 205 which is a slide switch for turning on and off the power source of wearable camera 200, and is provided with buttons such as a voice mute button, in addition thereto.

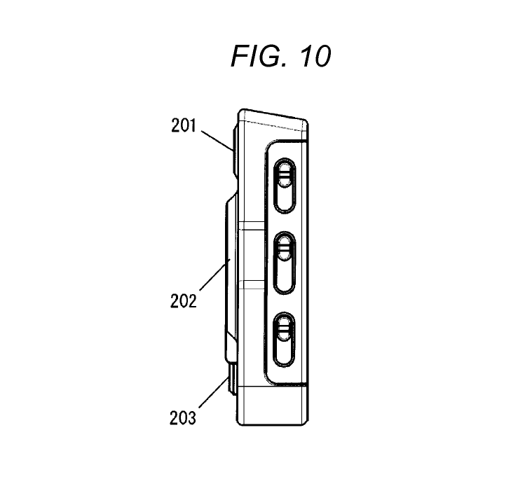

FIGS. 9 and 10 illustrates wearable camera 200 according to the present exemplary embodiment. FIG. 9 is a top view of wearable camera 200 according to the exemplary embodiment, and FIG. 10 is a side view (the right side view) of wearable camera 200 according to the exemplary embodiment.

In FIGS. 9 and 10, the same reference numerals and signs are applied to the elements described in FIG. 8, and descriptions will not be repeated. In the top view illustrated in FIG. 9, the overall portion surrounded by the dotted line is LED 204. In this case, in order to improve visual recognition, the shape of each of LEDS 204 is varied depending on the displaying item. For example, rectangular LEDS are used for displaying the state of capacity fade of a battery, and the like, and circular LEDS are used for displaying the state where video recording is carried out.

In a case of the configuration in which the top face of the body is inclined as described below, in order to lower the height where LED 204 is positioned, LED 204 is disposed in the area on the rear face side rather than a central portion of the top face.

Here, as is clear from the side view illustrated in FIG. 10, the most characteristic aspect of in wearable camera 200 according to the present exemplary embodiment is that the top face of the body is configured to be inclined so as to cause the rear face side to be lower than the front face side on which image capturing lens 201 is arranged. The number of switches in a group in wearable camera 200 illustrated in FIG. 10 is configured to be different from the number of switches in the group illustrated in FIGS. 2A and 2B.

In other words, an angle formed by the top face of the body and the front face is configured to be smaller than an angle formed by the top face and the rear face.

In other words again, the top face of the body is configured to not allow the imaging target to visually recognize light emitted from LED 204 which is provided on the top face of the body, that is, to cause the light to be blocked by the area of the top face on the front face side when seen from the imaging target.

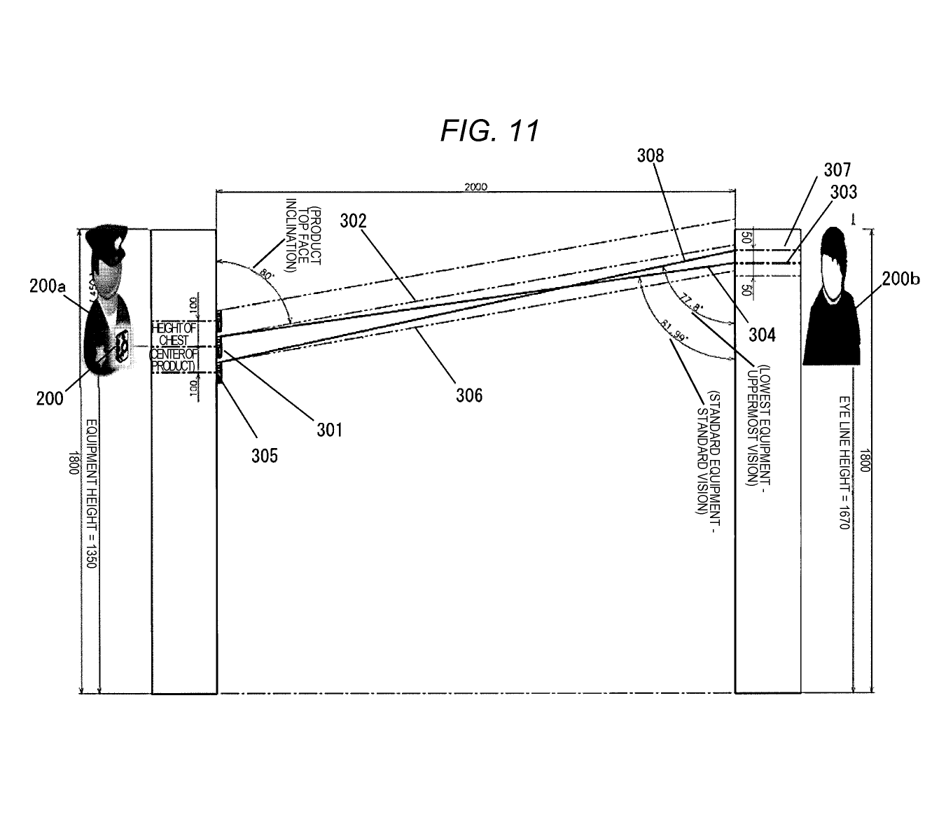

FIG. 11 is a diagram illustrating a necessary angle for an inclination angle of the top face of wearable camera 200 according to the exemplary embodiment. Hereinafter, the necessary angle for the inclination angle of top face of wearable camera 200 will be described with reference to FIG. 11 while explaining a relationship between a position of the top face of wearable camera 200 with which police officer 200a is equipped and a position of a line of vision of suspicious person 200b, in a case of a confrontation between police officer 200a and suspicious person 200b.

### Case of Standard Conditions

Reference numeral 301 represents a position of wearable camera 200 which is equipped on the chest when it is assumed that the height of police officer 200a is 180 cm. The two-dot chain line of reference numeral 302 represents an extension line of the inclination angle of the top face of wearable camera 200 (80 degrees with respect to the perpendicular line, that is, 10 degrees with respect to the horizontal line) in the forward direction, in the aforementioned condition.

Meanwhile, reference numeral 303 represents a position of the line of vision when it is assumed that the height of suspicious person 200b is 180 cm. The solid line of reference numeral 304 represents an extension line of vision in the forward direction toward the top face of wearable camera 200 indicated by reference numeral 301 in the aforementioned condition. When police officer 200a and suspicious person 200b approaches each other at a distance of 2 m, the angle of the line of vision is 81.99 degrees with respect to the perpendicular line, that is, 8.01 degrees with respect to the horizontal line.

In the above-described case, since the inclination angle (10 degrees) of the top face of wearable camera 200 is sufficiently greater than the angle (8.01 degrees) of the line of vision from suspicious person 200b, light from LED 204 disposed on the top face is blocked by the area of the top face on the front face side of wearable camera 200 so that the light cannot be visually recognized from suspicious person 200b.

In consideration of the average height of police officer 200a and the average height of suspicious person 200b that is an ordinary person (the heights of police officers are often higher than ordinary persons since police officers are subjected to height restriction on recruitment), the position of the line of vision of suspicious person 200b is lowered further. Therefore, as studied above, it is sufficient when the inclination angle of the top face of wearable camera 200 is 10 degrees or greater.

In the above-described case, the inclination angle is calculated on the assumption that the heights of police officer 200a and suspicious person 200b are 180 cm. However, there are differences in the average height depending on the countries and the regions. Nevertheless, it is considered that the relationship between the average heights of a police officer and an ordinary person is maintained. Therefore, the above-described consideration is effective regardless of the country or the region.

### Case of Strict Conditions

Reference numeral 305 represents a position of wearable camera 200 when the mounting position is lowered by 5 cm (or it is assumed that the height of police officer 200a is 175 cm). The two-dot chain line of reference numeral 306 represents an extension line of the inclination angle of the top face of wearable camera 200 (80 degrees with respect to the perpendicular line, that is, 10 degrees with respect to the horizontal line) in the forward direction, in the aforementioned condition.

Meanwhile, reference numeral 307 represents a position of the line of vision when the position of the line of vision of suspicious person 200b is raised by 2.5 cm (or it is assumed that the height of suspicious person 200b is 182.5 cm). The solid line of reference numeral 308 represents an extension line of vision in the forward direction toward the top face of wearable camera 200 indicated by reference numeral 305 in the aforementioned condition. When police officer 200a and suspicious person 200b approaches each other at a distance of 2 m, the angle of the line of vision is 77.8 degrees with respect to the perpendicular line, that is, 12.2 degrees with respect to the horizontal line.

In the above-described case, since the inclination angle (10 degrees) of the top face of wearable camera 200 is smaller than the angle (12.2 degrees) of the line of vision from suspicious person 200b, light from LED 204 disposed on the top face can be seen from suspicious person 200b. Therefore, in order to not allow suspicious person 200b to visually recognize light from LED 204 disposed on the top face, there is a need to increase the inclination angle of the top face of wearable camera 200 to at least 12.2 degrees, and preferably to 13 degrees or greater.

As studied hereinbefore, it is acceptable as long as the inclination angle of the top face of wearable camera 200 is 10 degrees or greater, and preferably 13 degrees or greater.

Regarding the allowable range of the inclination angle of the top face of wearable camera 200, it is reasonable for police officer 200a to have a range corresponding to 45 degrees so as to visually recognize wearable camera 200 when looking down. However, depending on the material of the uniform of police officer 200a, there is an occurrence of a disadvantage in that light of LED 204 is reflected by the uniform when the top face is inclined. Therefore, it is preferable that the inclination angle of the top face is smaller as much as possible (naturally, there is a need to be preferably 13 degrees or greater).

As described above, in wearable camera 200 according to the present exemplary embodiment, the top face of the body thereof is configured to be inclined so as to cause the rear face side to be lower than the front face side. In other words, the angle formed by the top face of the body and the front face is configured to be smaller than the angle formed by the top face and the rear face. In other words again, the top face of the body is configured to not allow the imaging target to visually recognize light emitted from LED 204 which is provided on the top face of the body, that is, to cause the light to be blocked by the area of the top face on the front face side when seen from the imaging target.

Accordingly, emission of light from the LED which displays the video recording state can be prevented from being visually recognized from the front.

LED 204 on the top face of the body is disposed in the area on the rear face side rather than the central portion of the top face.

Accordingly, since the height at which the display is positioned can be lowered with respect to the front face side of the top face, the display can be hidden from the imaging target side even though the display is a light emitter.

The inclination angle formed by the top face of the body is 10 degrees or greater with respect to the horizontal plane, and is preferably 13 degrees or greater.

Accordingly, the display can be hidden from the imaging target side even though the imaging target approaches near wearable camera 200.

It is desirable that wearable camera 200 is used by being equipped on the chest. However, police officer 200a may be equipped on other sites, for example, on the top of the shoulder so as to cause wearable camera 200 to confront suspicious person 200b when police officer 200a turns away.

### Another Alternative Exemplary Embodiment

In another alternative exemplary embodiment, a configuration different from the configuration of the top face of wearable camera 200 illustrated in the aforementioned exemplary embodiment will be described.

Particularly, a case where the inclination angle of the top face of wearable camera 200 described above to be preferable cannot be ensured will be also mentioned. The case where the inclination angle cannot be ensured denotes a case where there are disadvantages such as restrictions on actual mounting, and reflection of light with respect to the uniform and the like.

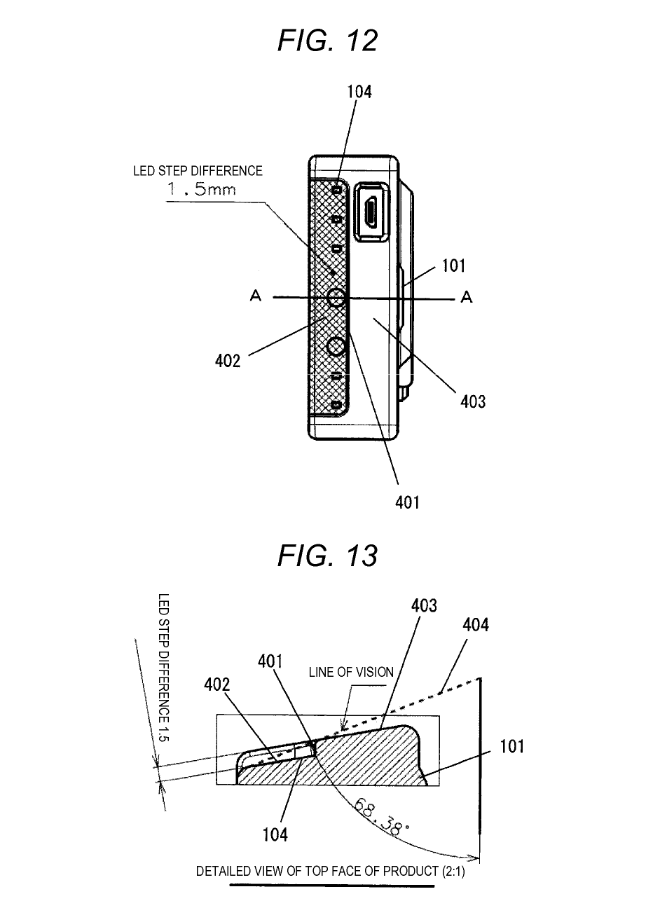

FIGS. 12 and 13 are diagrams illustrating the inclination angle and a step difference of the top face of wearable camera 200 according to the present exemplary embodiment. FIG. 12 is a top view of wearable camera 200 according to the exemplary embodiment. In the descriptions, the same reference numerals and signs will be applied to the portions overlapping with wearable camera 200 according to the aforementioned exemplary embodiment.

In FIG. 12, on the top face of wearable camera 200, lower step difference 402 and upper step difference 403 are formed by step difference 401 provided on the top face. The portion illustrated in half-tone dot meshing in the area of the top face on the rear face side corresponds to lower step difference 402 when seen from the front face where image capturing lens 201 is disposed.

LED 204 is disposed in lower step difference 402. In this case, LED 204 is disposed in the area close to step difference 401 on lower step difference 402.

Here, as is clear from the descriptions above, the most characteristic aspect of in wearable camera 200 according to the present exemplary embodiment is that the top face of the body is configured to have the step difference so as to cause the rear face side to be lower than the front face side, and LED 204 is configured to be disposed on the top face of step difference 401 on the rear face side.

FIG. 13 is a cross-sectional view taken along line A-A illustrating an enlarged configuration of the top face portion of wearable camera 200 illustrated in FIG. 12.

In FIG. 13, the top face of wearable camera 200 is configured to include step difference 401 having a height of 1.5 mm so as to cause lower step difference 402 on the rear face side to be lower than upper step difference 403 on the front face side. The inclination angle of the top face is 10 degrees same as that in the first exemplary embodiment.

The dotted line of reference numeral 404 represents a virtual inclination angle of the top face formed by connecting an apex of an angle formed by step difference 401 and upper step difference 403, and an apex of an angle formed by lower step difference 402 and the rear face. The angle of the inclination angle is 68.38 degrees with respect to the perpendicular line, that is, 21.62 degrees with respect to the horizontal line.

That is, according to the configuration of the present exemplary embodiment, even though the actual inclination angle of the top face is 10 degrees, it is possible to ensure the virtual inclination angle of 21.62 degrees. Therefore, the angle at which the top face is inclined can be minimized. For example, it is extremely effective in a case where there is an occurrence of a disadvantage in that light of LED 204 is reflected by the uniform depending on the material of the uniform of police officer 200a, when the top face is inclined.

As described above, since the top face of the body of wearable camera 200 is configured to have the step difference so as to cause the rear face side to be lower than the front face side, and the display is configured to be disposed on the top face of the step difference on the rear face side, even though it is not possible to achieve the inclination angle to be 10 degrees or greater, and preferably 13 degrees or greater, the display can be hidden from the imaging target side.

Since the display is disposed in the area of lower step difference 402 close to step difference 401 on the top face on the rear face side, even though the imaging target approaches near wearable camera 200, the display can be hidden from the imaging target side.

The inclination angle of lower step difference 402 is not necessarily equal to that of upper step difference 403. For example, lower step difference 402 may be horizontal.

What is claimed is:

1. A wearable camera comprising:
a body;
a video recording button that is provided on a frontal face of the body in an area on one side having one center line on the frontal face as a boundary; and
a mode changeover switch that is provided on a side of the body existing in the area on the one side,
wherein the mode changeover switch includes an operating section which is directly operated by an operator, and a linear slot in which the operating section moves, and
wherein a most-frequently-used mode having the highest frequency of use in case of emergency is positioned on at least one end of the slot.

2. The wearable camera of claim 1,
wherein the most-frequently-used mode is a mode for performing communication with a portable electrical apparatus.

3. The wearable camera of claim 1,
wherein a communication off mode is positioned in the other end of the slot.

4. The wearable camera of claim 3,
wherein at least one external apparatus connection mode which can be connected to an external apparatus is positioned between the one end and the other end of the slot.

5. A wearable camera comprising, within a body of the camera performing image capturing processing:
an imaging lens which captures an image of an imaging target; and
a display which displays a state related to the image capturing processing,
wherein the imaging lens is disposed on a front face of the body,
wherein the display is disposed on a top face of the body, and
wherein the top face of the body is configured to be inclined so as to cause a rear face side to be lower than the front face side in order to not allow the imaging target to visually recognize light emitted from the display which displays a video recording state.

6. The wearable camera of claim 5,
wherein the display is configured to be formed with a light emitter.

7. The wearable camera of claim 5,
wherein the display is disposed in an area on the rear face side from a central portion on the top face of the body.

8. The wearable camera of claim 5,
wherein an inclination angle formed by the top face of the body is equal to or greater than a predetermined angle with respect to a horizontal plane.

9. The wearable camera of claim 8,
wherein the top face of the body is configured to have a step difference so as to cause the rear face side to be lower than the front face side, and
wherein the display is configured to be disposed on the top face of the step difference on the rear face side.

10. A wearable camera comprising, within a body of the camera performing image capturing processing:
an imaging lens which captures an image of an imaging target, and
a display which displays a state related to the image capturing processing,
wherein the imaging lens is disposed on a front face of the body,
wherein the display is disposed on a top face of the body, and
wherein an angle formed by the top face and the front face of the body is configured to be smaller than an angle formed by the top face and the rear face in order to not allow the imaging target to visually recognize light emitted from the display which displays a video recording state.

11. A wearable camera comprising, within a body of the camera performing image capturing processing:
an imaging lens which captures an image of an imaging target, and
a display which displays a state related to the image capturing processing,
wherein the imaging lens is disposed on a front face of the body,
wherein the display is disposed on a top face of the body, and
wherein the top face of the body is configured to be blocked by an area of the top face on the front face side in order to not allow the imaging target to visually recognize light emitted from the display which displays the video recording state.
